(19) United States
(12) Patent Application Publication
(10) Pub. No.: US 2016/0349791 A1
(43) Pub. Date: Dec. 1, 2016

(54) VIRTUAL REALITY HEADSET AND DEVICE CASE

(71) Applicant: GOOGLE INC., Mountain View, CA (US)

(72) Inventors: Christian PLAGEMANN, Palo Alto, CA (US); David COZ, Mountain View, CA (US); Matthew Thomas VALENTE, Mountain View, CA (US); Peter Gregory BRUECKNER, Santa Cruz, CA (US)

(21) Appl. No.: 15/164,419

(22) Filed: May 25, 2016

Related U.S. Application Data
(60) Provisional application No. 62/167,120, filed on May 27, 2015.

(51) Int. Cl. G06F 1/16; G02B 27/02; G02B 27/04

(52) U.S. Cl. CPC G06F 1/1609; G02B 27/04; G02B 27/028

(57) ABSTRACT

A device includes a top cover, a bottom cover connected to the top cover, where the bottom cover is configured to hold an electronic device, and one or more components of a virtual reality headset configured to fold flat on an inner side of the top cover. The components of the virtual reality headset may include a lens frame assembly and a support member.

### CROSS REFERENCE TO RELATED APPLICATIONS

This application claims the benefit of U.S. application Ser. No. 62/167,120, filed on May 27, 2015, titled “Virtual Reality Headset and Device Case,” which is incorporated herein by reference in its entirety.

### TECHNICAL FIELD

This description relates to a combined virtual reality headset and device case. More specifically, this description relates to a virtual reality headset that functions as both a virtual reality headset and a device case for an electronic device running virtual reality applications.

### SUMMARY

According to one general aspect, a device includes a top cover, a bottom cover connected to the top cover, where the bottom cover is configured to hold an electronic device, and one or more components of a virtual reality headset configured to fold flat on an inner side of the top cover.

Implementations may include one or more of the following features. For example, the components of the virtual reality headset may include a lens frame assembly and a support member.

In another general aspect, an apparatus includes a device case for holding an electronic device and one or more components for a virtual reality headset configured to fold flat within the device case and to unfold to provide the virtual reality headset for viewing virtual content displayed on the electronic device.

In another general aspect, an apparatus includes means for holding an electronic device and the apparatus includes one or more components for a virtual reality headset configured to fold flat within the means for holding the electronic device and to unfold to provide the virtual reality headset for viewing virtual content displayed on the electronic device.

The details of one or more implementations are set forth in the accompanying drawings and the description below. Other features will be apparent from the description and drawings, and from the claims.

### BRIEF DESCRIPTION OF THE DRAWINGS

FIG. 1 is an example drawing illustrating a perspective view for a virtual reality headset and device case in a closed position.

FIG. 2 is an example drawing illustrating a perspective view for the virtual reality headset and device case of FIG. 1 in an open position.

FIG. 3 is an example drawing illustrating a perspective view for the virtual reality headset and device case of FIG. 1 in an open position with a lens frame assembly popped out.

FIG. 4 is an example drawing illustrating a perspective view for the virtual reality headset and device case of FIG. 1 in an open position with the lens frame assembly popped out and a support member supporting the lens frame assembly.

FIG. 5 is an example drawing illustrating user holding the virtual reality headset and device case of FIG. 1 in virtual reality headset in an open and viewing position.

FIG. 6 is an example drawing illustrating a virtual reality headset and device case in a closed position.

FIG. 7 is an example drawing illustrating the virtual reality headset and device case of FIG. 6 in an open position.

### DETAILED DESCRIPTION

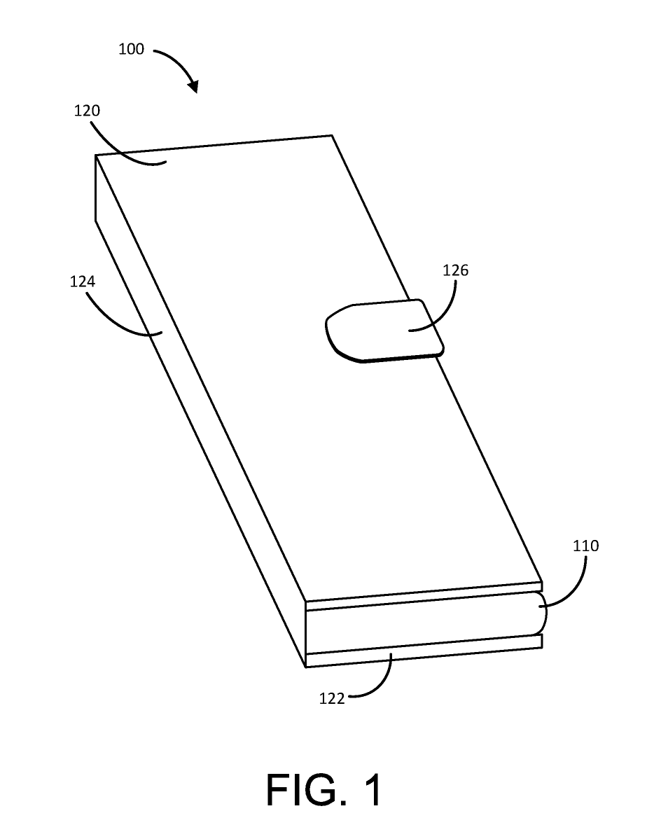

FIG. 1 is an example drawing illustrating a perspective view for a virtual reality headset and device case 100 (or device case 100) in a closed position. The device case 100 may be used to hold and transport an electronic device such as electronic device 110. In this closed position (or closed configuration), the components for the virtual reality headset are folded flat inside the device case 100. In this manner, the device case 100 easily transports and protects the electronic device 110 and the components for the device case 100 to function as a virtual reality headset. In the closed position, the device case 100 may be carried in a pocket or a bag.

The device case 100 may be made of any type of material including, but not limited to, cardboard, leather, plastic, vinyl, suede, polycarbonate, carbon fiber, silicone, metal, other types of materials and combinations of these materials. In some implementations, at least one portion or part or component of the device case 100 may be made of one material and at least one other portion or part or component may be made of a different material.

The device case 100 may be sized to fit a particular type of electronic device 110. For example, the electronic device 110 may include a smart phone, a tablet, or other type of computing device and the device case 100 may be sized to fit particular brands and/or models of these devices.

In one example implementation, the device case 100 includes a top cover 120, a bottom cover 122 and a connector 124 that connects the top cover 120 and the bottom cover 122. The connector 124 enables the top cover 120 to open and close while the bottom cover 122 supports the electronic device 110. The connector 124 extends along the length of the top cover 120 and the bottom cover 122. While the connector 124 is illustrated as extending along the length of both the top cover 120 and the bottom cover 122, it is understood that the connector 124 may extend along only a portion of the length of the top cover 120 and the bottom cover 122. Also, it is understood that the connector 124 may include multiple pieces, such as multiple strips, instead of a single piece, as illustrated.

The device case 100 includes a closure mechanism 126. In this example, the closure mechanism 125 may be a strip of material fixed to the bottom cover 122 and that extends over the opening between the bottom cover 122 and the top cover 120 and removably attaches to the top cover 120 to secure the device case 100 in a closed position. The closure mechanism 126 lifts up from the top cover 120 to enable the device case 100 to be opened for access to the electronic device 110 and the components for the virtual reality headset.

The closure mechanism 126 may use different types of fasteners to secure the closure flap to the top cover 120. For instance, the closure mechanism may use magnets, snaps, hook and loop fasteners or other types of fasteners.

It is understood that this is merely one example implementation for a device case 100 and that the device case 100 may be implemented in other configurations that enable the device case to at least partially enclose the electronic device 110 and to stow the components for the virtual reality headset in a folded manner such that the components for the virtual reality headset lay flat inside the device case.

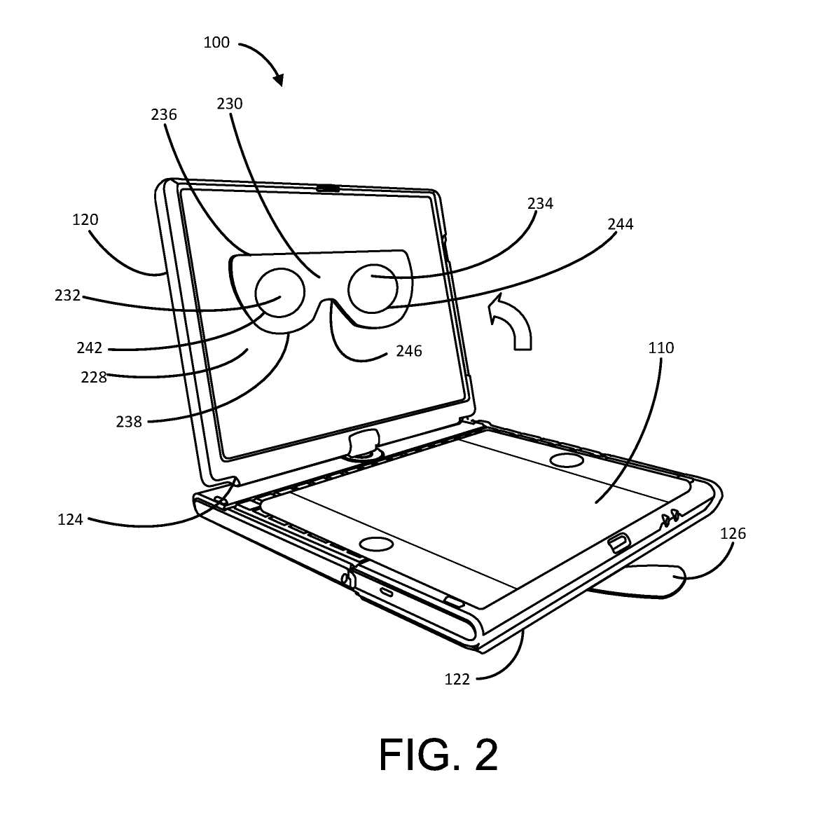

Referring to FIG. 2, the device case 100 is illustrated in an open position. In FIG. 2, the closure mechanism 126 has been unfastened from the top cover 120 to enable the top cover 120 to be moved away from the bottom cover 122 to open the device case 100, as indicated by the arrow in the figure. In the open configuration, the device case 100 provides access to the electronic device 100. The electronic device 100 may be used when the device case 100 is opened.

The electronic device 110 may be secured to the inner side of the bottom cover 122. For example, the electronic device 110 may be secured by one or more corner straps (not shown) or may fit snugly into a frame defined by the inner side of the bottom cover 122. It is understood that other means may be used to secure the electronic device 110 to the inner side of the bottom cover 122.

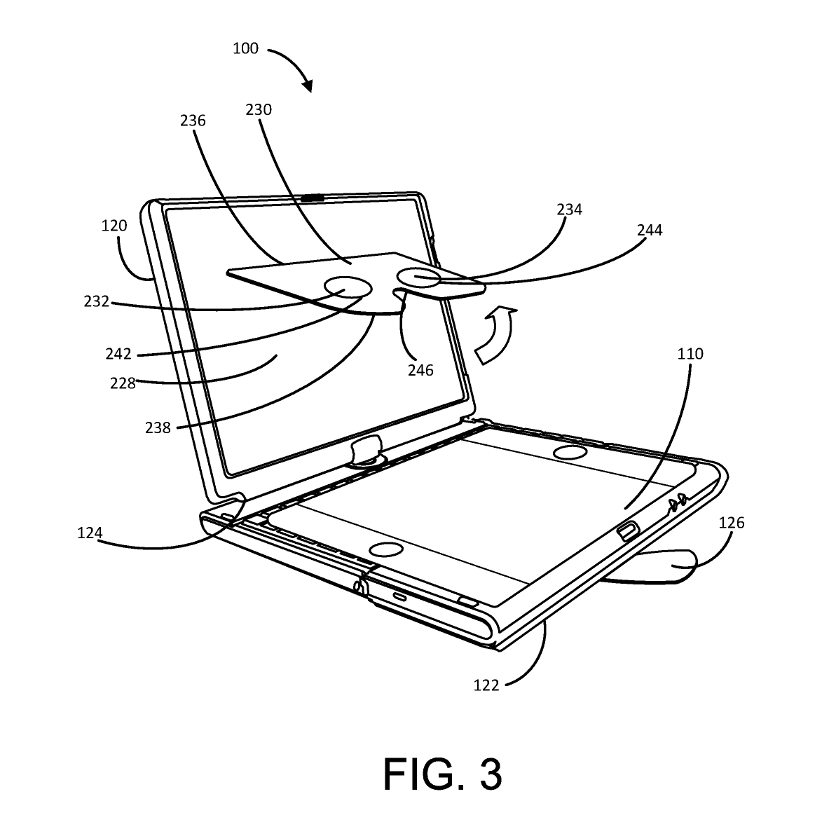

In the open position, one or more of the components for the virtual reality headset are revealed as stowed flat along the inner side 228 of the top cover 120. The virtual reality headset components include a lens frame assembly 230. The lens frame assembly 230 includes a first lens 232 and a second lens 234 secured in the lens frame assembly 230. A top edge 236 of the lens frame assembly 230 may be hingedly affixed to the inner side 228 of the top cover 120 such that the bottom edge 238 of the lens frame assembly 230 may be moved away from the inner side 228 of the top cover 120, as illustrated in FIG. 3 and described below. The top edge 236 may be secured to the inner side 228 of the top cover 120 by an adhesive (e.g., glue, tape, etc.) depending on the type of material used for the lens frame assembly 230 and the top cover 120. The lens frame assembly 230 may be made from the same material as the top cover 120 or from a different material, selected from the materials described above with respect to the device case 100.

The lens frame assembly 230 can include a pair of lenses (e.g., a pair of aspherical lenses) 232 and 234 that are disposed (affixed, mounted, etc.) in openings 242 and 244 in the lens frame assembly 230. A focal length of the lenses 232, 234 can be selected based on the physical dimensions of the virtual reality headset. In one example implementation, the lens frame assembly 230 may include a three-layer stack (e.g., three layers of die-cut cardboard), a first outer layer, an inner layer and a second outer layer, each with a lens opening 242, 244 for each of the lenses 232, 234. The inner layer may have circular lens openings in which the lenses 232, 234 are disposed. The two outer layers may each include a plurality of tabs (not shown) that are disposed around their lens openings 242, 244 to hold the lenses 232, 234 in place in the lens frame assembly 230 (e.g., with the lens openings 242, 244 on the inner layer). In other approaches, the lenses 232, 234 may be mounted (affixed, etc.) in the lens frame assembly 230 using other means. The tabs (not shown) can be sized such that they do not occlude or significantly occlude the lenses 232, 234, or significantly reduce the field of view of the lenses 232, 234 when viewing virtual reality content that is presented on the electronic device 110 secured in the device case 100.

In one implementation, the lenses 232, 234 may be uncovered where the glass for the lenses is exposed. In another implementation, the lenses 232, 234 may be covered with covers (e.g., removable covers) that may be used to protect the glass for the lenses.

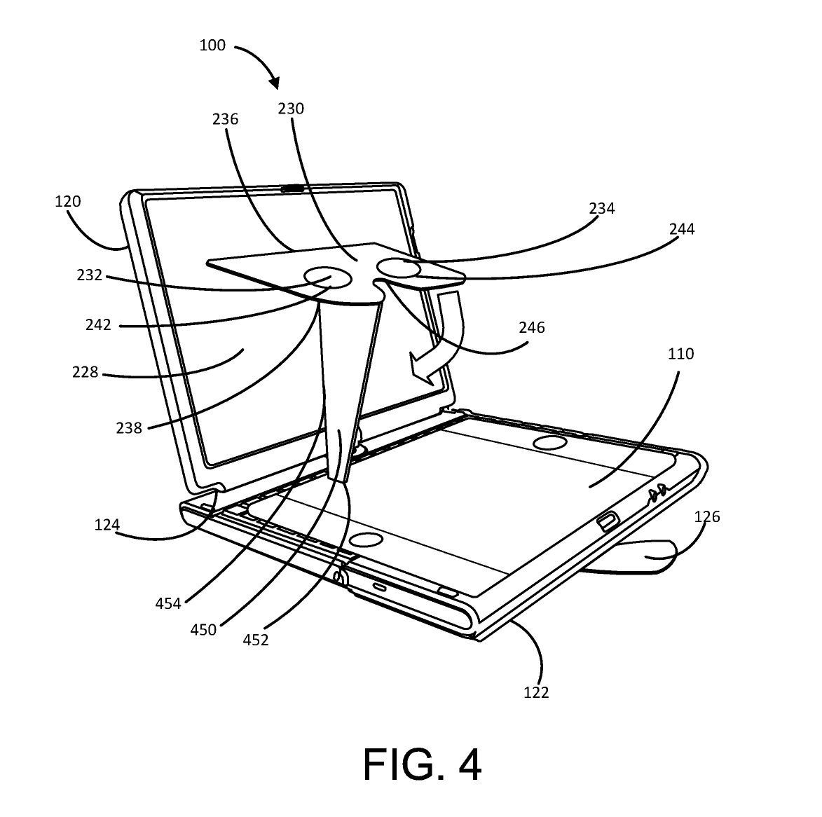

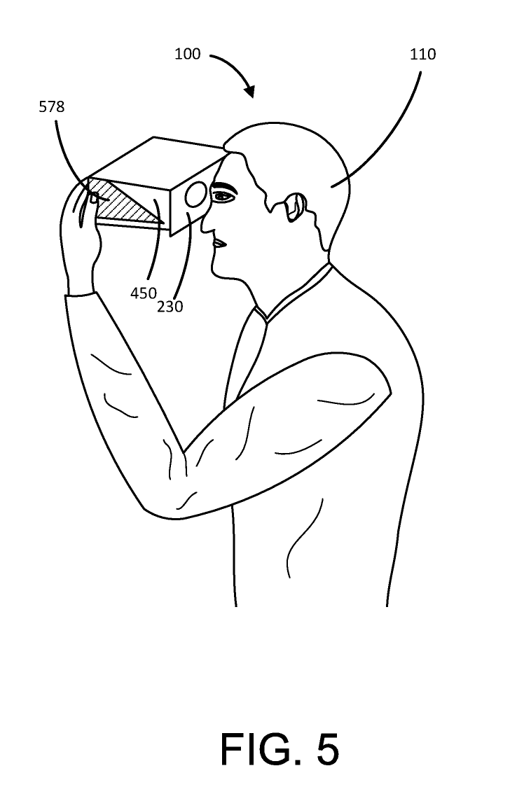

The lens frame assembly 230 includes a nose bridge cutout 246. The nose bridge cutout 246 is configured to allow a user to rest the lens frame assembly 230 on the bridge of their nose while looking through the lenses 232, 234 to view the display of the electronic device 110 to watch virtual reality content when the lens frame assembly is in the viewing position, as shown in FIGS. 4 and 5.

Referring to FIG. 3, the device case 100 is illustrated in an open position with the lens frame assembly 230 rotated away from the inner side 228 of the top cover 120, as illustrated by the arrow in the figure. Referring to FIG. 4, the device case 100 includes a support member 450, which is one of the virtual reality headset components that lays flat along the inner side 228 of the top cover 120. The support member 450 may be attached to the lens frame assembly 230 or may be integrally formed as part of the lens frame assembly 230. The support member 450 may lay flat along one side of the lens frame assembly 230 and then rotate away from the lens frame assembly 230, as shown by the arrow, so that a distal end 452 of the support member 450 may support and secure the lens frame assembly 230 in a viewing position.

In one implementation, the distal end 452 of the support member 450 may be wide enough on its end to rest against the display of the electronic device 110 to hold the lens frame assembly 230 in position. In other implementations, a top edge 454 of the support member 450 may attach to the inner side 228 of the top cover 120. For example, the inner side 228 of the top cover 120 may include a notch or slot that the top edge 454 of the support member 450 may fit into while the distal end 452 rests on the electronic device 110. In another implementation, the top edge 454 of the support member 450 may include a magnet and may magnetically attach to the inner side 228 of the top cover 120.

In the one implementation illustrated in FIG. 4, the support member 450 is a single member located in the middle of the lens frame assembly 230. In other implementations (not shown), two support members may be used with one on each side of the lens frame assembly 230. Like the single support member in the middle, the two support members would fold in flat for storing against the lens frame assembly 203 along the inner side 228 of the top cover 120. The two support members can be unfolded and then secured against the electronic device to support the lens frame assembly 230 in the viewing position.

Referring to FIG. 5, with the support member 450 in place, the device case 100 is in a viewing position to enable a user 575 to view virtual reality content displayed on a display 578 of the electronic device 110 through the lens frame assembly 230. The display 578 may include a touch screen display to enable the user 575 to interact with the virtual content through the touch screen. Virtual reality applications or content can be executed on the electronic device 110, which is secured in the device case 100, as described herein. The user 575 can then view images associated with (produced by) such virtual reality applications or content that are displayed on the display panel 578 of the electronic device 110 using the lens frame assembly 230 to experience the content as virtual reality content (e.g., in a virtual 3-dimensional view). The support member 450 may be sized to provide the optimal distance between the lens frame assembly 230 and the display 578 for viewing the virtual reality content.

When done viewing content, the lens frame assembly 230 and the support member 450 may be folded flat against the inner side 228 of the top cover 120. The device case 100 may be closed in a closed position as shown in FIG. 1 for transporting and carrying both the electronic device 110 and the components for the virtual reality headset. The components for the virtual reality headset can be folded in place using mechanical force or magnets. If magnets are used, the magnets may retain the lens frame assembly 230 and the support member 450 against the inner side 228 of the top cover 120.

In one implementation, the lens frame assembly 230 may be positioned inside a protective pouch (not shown) or other protective cover (not shown) along with the support member 450. The protective pouch may be affixed to the inner side 228 of the top cover 120. When the device case 100 is open, the lens frame assembly 230 may be removed from the protective pouch and affixed into position along with the support member 450 to enable the user to view the virtual content on the electronic device 110.

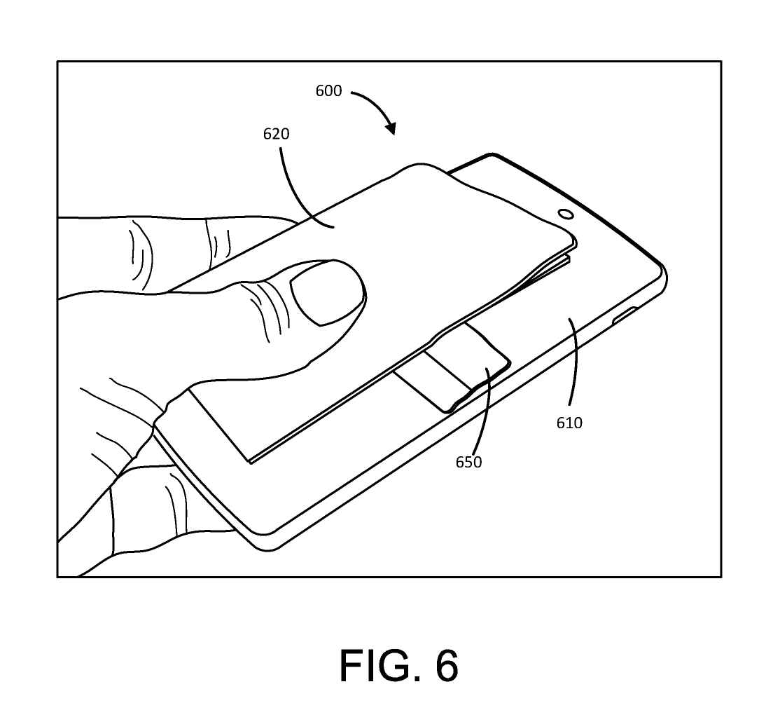

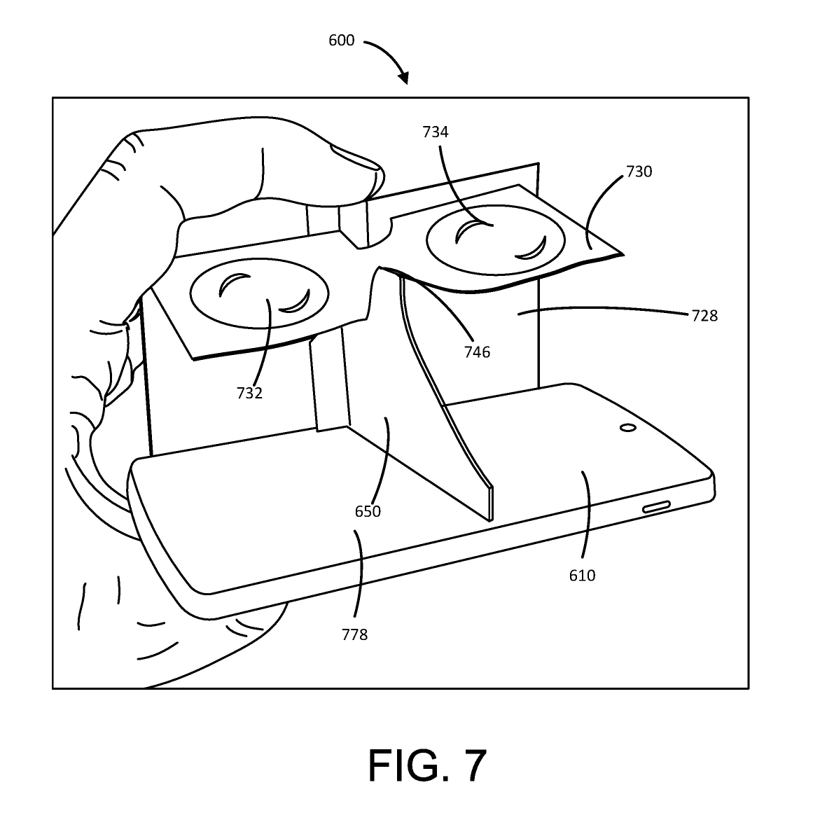

Referring to FIGS. 6 and 7, an example device case 600 is illustrated. FIG. 6 illustrates the device case 600 in a closed position and FIG. 7 illustrates the device case 600 in a viewing position or viewing configuration. The device case 600 includes a top cover 620 and a bottom cover (not shown) that fold around an electronic device 610 to protect the electronic device 600 while transporting the electronic device 600. The device case 600 may be made of the materials described above with respect to the device case 100 of FIG. 1. As with the device case 100 of FIGS. 1-5, the device case 600 may include the components for the virtual reality headset, including a lens frame assembly 730 and a support member 650 as part of the device case 600. In the closed position, the components for the virtual reality headset may lay flat on the inner side 728 of the top cover 620.

In the open and viewing configuration, the device case 600 includes the lens frame assembly 730 having lenses 732 and 734 with a nose bridge cutout 746. The lens frame assembly 730 may include the same or similar features to the lens frame assembly 230, as described above. The support member 650 may support the lens frame assembly 730 and secure it in place against the display 778 of the electronic device 610. The support member 650 may be sized such that the lens frame assembly is the optimal viewing distance from the display 778 for a user to view virtual reality content on an application running on the electronic device 610.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a touch screen display, a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A device comprising:
a top cover;
a bottom cover connected to the top cover, the bottom cover configured to hold an electronic device; and
one or more components of a virtual reality headset configured to fold flat on an inner side of the top cover.

2. The device of claim 1 wherein the one or more components of the virtual reality headset are configured to fold out from the inner side of the top cover and to position the components in a viewing position.

3. The device of claim 1 wherein the one or more components of the virtual reality headset comprise a lens frame assembly and a support member.

4. The device of claim 3 wherein the lens frame assembly comprises a first lens and a second lens disposed and secured in openings in the lens frame assembly.

5. The device of claim 3 wherein a top edged of the lens frame assembly is hingedly affixed to the inner side of the top cover.

6. The device of claim 3 wherein the lens frame assembly comprises a nose bridge cutout.

7. The device of claim 3 wherein the support member is attached to the lens frame assembly and a distal end of the support member is configured to rotate away from the lens frame assembly and secure the lens frame assembly in a viewing position.

8. The device of claim 1 further comprising a connector to connect the top cover and the bottom cover.

9. The device of claim 8 wherein the connector extends along a length of the top cover and the bottom cover.

10. The device of claim 1 further comprising a closure mechanism to secure the top cover and the bottom cover in a closed position.

11. The device of claim 1 wherein the top cover, the bottom cover and the one or more components of the virtual reality headset are made of cardboard.

12. An apparatus comprising:
a device case for holding an electronic device; and
one or more components for a virtual reality headset configured to fold flat within the device case and to unfold to provide the virtual reality headset for viewing virtual content displayed on the electronic device.

13. The apparatus of claim 12 wherein the device case comprises:
a top cover; and
a bottom cover connected to the top cover, the bottom cover configured to hold the electronic device.

14. The apparatus of claim 13 wherein the one or more components of the virtual reality headset are configured to fold out from an inner side of the top cover and to position the components in a viewing position.

15. The apparatus of claim 12 wherein the one or more components of the virtual reality headset comprise a lens frame assembly and a support member.

16. The apparatus of claim 15 wherein the lens frame assembly comprises a first lens and a second lens disposed and secured in openings in the lens frame assembly.

17. The apparatus of claim 15 wherein the lens frame assembly comprises a nose bridge cutout.

18. The apparatus of claim 15 wherein the support member is attached to the lens frame assembly and a distal end of the support member is configured to rotate away from the lens frame assembly and secure the lens frame assembly in a viewing position.

19. The apparatus of claim 13 further comprising a connector to connect the top cover and the bottom cover.

20. The apparatus of claim 19 wherein the connector extends along a length of the top cover and the bottom cover.
